(19) United States
(12) Patent Application Publication
(10) Pub. No.: US 2014/0138373 A1
(43) Pub. Date: May 22, 2014

(54) CERAMIC HEATER-TYPE GLOW PLUG

(71) Applicant: BOSCH CORPORATION, Tokyo (JP)

(72) Inventor: Katsumi Takatsu, Saitama (JP)

(73) Assignee: BOSCH CORPORATION, Tokyo (JP)

(21) Appl. No.: 14/129,870

(22) PCT Filed: Apr. 4, 2012
(86) PCT No.: PCT/JP2012/059165

§ 371 Date: Dec. 27, 2013

(30) Foreign Application Priority Data
Jun. 29, 2011 (JP) 2011-144496

(51) Int. Cl. F23Q 7/00; F02P 19/02

(52) U.S. Cl. CPC F23Q 7/001; F02P 19/026
USPC 219/270; 123/145 A

(57) ABSTRACT

A ceramic heater-type glow plug is provided that is configured so that, even when a deformation occurs in a metal outer cylinder, stress propagating to the connection between one electrode of a ceramic heater and an electrode lead-out member can be reduced to prevent the ceramic heater and the electrode lead-out member from being damaged.

In the ceramic heater-type glow plug in which heat-resistant insulating particles are sealed into the metal outer cylinder as a sealing material, at least an area around the connection between the one electrode and the electrode lead-out member is filled with a mixed insulating powder mixed with a lubricity enhancing material for improving lubricity among the heat-resistant insulating particles.

### BACKGROUND OF THE INVENTION

The present invention relates to a ceramic heater-type glow plug used as a starting aid for a diesel engine. Particularly, the invention relates to a ceramic heater-type glow plug having a configuration in which a heat-resistant insulating powder as a sealing material is sealed into a metal outer cylinder for holding a ceramic heater.

A ceramic heater-type glow plug used as a starting aid for a diesel engine generally has a structure in which a heating element on the tip side of a ceramic heater is protruded to the outside and the rear end side of the ceramic heater is held within a metal outer cylinder. In this ceramic heater-type glow plug, the rear end side of the metal outer cylinder is inserted into and fixed within the frond end of a cylindrical housing that is mounting hardware for mounting to a cylinder head of an engine.

Furthermore, one electrode of the ceramic heater (negative electrode) is led out to the outer surface of the heater body and electrically connected to the inner surface of the metal outer cylinder, while the other electrode (positive electrode) is led out from the rear end side to the outside by an electrode lead-out hardware. The electrode led out to the outside by the electrode lead-out hardware is electrically connected to an outside connection terminal fixed to the rear end side of the housing by an insulating member.

In this ceramic heater-type glow plug, in order to connect the positive electrode of the ceramic heater to the electrode lead-out hardware, the rear end of the ceramic heater is ground to form a smaller diameter portion or a taper is formed on the rear end of the ceramic heater.

In manufacturing the ceramic heater-type glow plug configured as described above, the ceramic heater is fixed to the metal outer cylinder by inserting the rear end side of the ceramic heater into the metal outer cylinder, then sealing heat-resistant insulating particles into the metal outer cylinder and swaging the metal outer cylinder to decrease the diameter of the metal outer cylinder (see WO2005-061963).

### SUMMARY OF INVENTION

However, since the heat-resistant insulating particles sealed into the metal outer cylinder have relatively high solidity, when deformation of the metal outer cylinder or the like occurs due to swaging, stress may propagate through the heat-resistant insulating particles to the connection between the positive electrode of the ceramic heater and the electrode lead-out hardware, which may damage the rear end of the ceramic heater and the electrode lead-out hardware.

The present inventor found that the above-described problem can be solved by mixing a lubricity enhancing material into heat-resistant insulating particles at least around the connection between one electrode of the ceramic heater and the electrode lead-out hardware and thus completed the invention. Thus, it is an object of the present invention to provide a ceramic heater-type glow plug that is configured so that, even when a deformation occurs in the metal outer cylinder, stress propagating to the connection between one electrode of the ceramic heater and the electrode lead-out member can be reduced to prevent the ceramic heater and the electrode lead-out member from being damaged.

According to the invention, a ceramic heater-type glow plug is provided to solve the above-described problem, the ceramic heater-type glow plug comprising: a ceramic heater; a metal outer cylinder holding the ceramic heater at one end side and having the other end side inserted into an inner hole of a housing and fixed to the housing; and an electrode lead-out member connected to one electrode of the ceramic heater within the metal outer cylinder, wherein heat-resistant insulating particles are sealed into the metal outer cylinder as a sealing material, and wherein at least an area around the connection between the one electrode and the electrode lead-out member is filled with a mixed insulating powder mixed with a lubricity enhancing material for improving lubricity among the heat-resistant insulating particles.

Specifically, the ceramic heater-type glow plug in accordance with the invention is configured to fill at least an area around the connection between the one electrode of the ceramic heater and the electrode lead-out member with the mixed insulating powder mixed with the lubricity enhancing material, so, even when deformation of the metal outer cylinder or the like occurs, slip occurs among the heat-resistant insulating particles, which can reduce stress propagating to the connection. Thus, damage of the ceramic heater and the electrode lead-out member can be reduced.

Furthermore, in the ceramic heater-type glow plug of the invention, preferably, the lubricity enhancing material has an average particle diameter smaller than that of the heat-resistant insulating particles.

Mixing this lubricity enhancing material into the heat-resistant insulating particles can facilitate the intervening of the lubricity enhancing material among the heat-resistant insulating particles. Furthermore, employing this lubricity enhancing material can increase the filling density of the mixed insulating powder, which can tightly hold the electrode lead-out member and another member inserted into the metal outer cylinder and can also efficiently dissipate heat generated from the electrode lead-out member.

Furthermore, in the ceramic heater-type glow plug of the invention, preferably, the lubricity enhancing material has a heat conductivity higher than that of the heat-resistant insulating particles.

Mixing this lubricity enhancing material into the heat-resistant insulating particles can facilitate propagation of heat generated by large current flowing in the electrode lead-out member when the ceramic heater is operating to the metal outer cylinder and the housing, preventing oxidation of the electrode lead-out member.

Furthermore, in the ceramic heater-type glow plug of the invention, preferably, the mixing ratio of the heat-resistant insulating particles and the lubricity enhancing material is determined so that the tapping density of the mixed insulating powder will be higher than that of the heat-resistant insulating particles.

Determining the mixing ratio of the heat-resistant insulating particles and the lubricity enhancing material in this way can increase the filling density of the mixed insulating powder, which can tightly hold the electrode lead-out member and another member inserted into the metal outer cylinder and can also efficiently dissipate heat generated from the electrode lead-out member.

Furthermore, in the ceramic heater-type glow plug of the invention, preferably, the heat-resistant insulating particles are magnesia (MgO), and the lubricity enhancing material is hexagonal boron nitride (h-BN).

Employing these materials to configure the mixed insulating powder can provide the ceramic heater-type glow plug that is filled with the mixed insulating powder superior in heat resistance, electrical insulation performance, heat conductivity and lubricity, has the ceramic heater and the electrode lead-out member less likely to be damaged, and is superior in heating efficiency.

Furthermore, in the ceramic heater-type glow plug of the invention, preferably, the mixed insulating powder is sealed into the whole metal outer cylinder.

With the one type of mixed insulating powder to be sealed as described above, the metal outer cylinder can be filled with the heat-resistant insulating particles in one step, which can improve the production efficiency of the ceramic heater-type glow plug.

### BRIEF DESCRIPTION OF DRAWINGS

FIG. 1 is a cross-sectional view of a glow plug for diesel engine.

FIG. 2 is a diagram illustrating the manufacturing process of a ceramic heater assembly.

FIG. 3 is a diagram illustrating how stress applied to a mixed insulating powder propagates.

FIG. 4 is a diagram illustrating a stress distribution within a metal outer cylinder while being swaged.

FIG. 5 is a diagram showing a result of measuring the tapping density versus the mixed amount of h-BN in an example.

FIG. 6 is a diagram illustrating the configuration of a ceramic heater assembly in the example.

FIG. 7 is a diagram showing a result of measuring the resistance value of the ceramic heater assembly versus the mixed amount of h-BN in the example.

FIG. 8 is a diagram showing a result of measuring the surface temperature versus the mixed amount of h-BN in the example.

FIG. 9 is a diagram showing a result of measuring the power consumption versus the mixed amount of h-BN in the example.

### DETAILED DESCRIPTION

An embodiment of a ceramic heater-type glow plug in accordance with the invention is specifically described below based on the drawings.

Unless otherwise specified, through the drawings, like reference numerals denote like components, and their descriptions are appropriately omitted.

### First Embodiment

### 1. Basic Configuration of Glow Plug

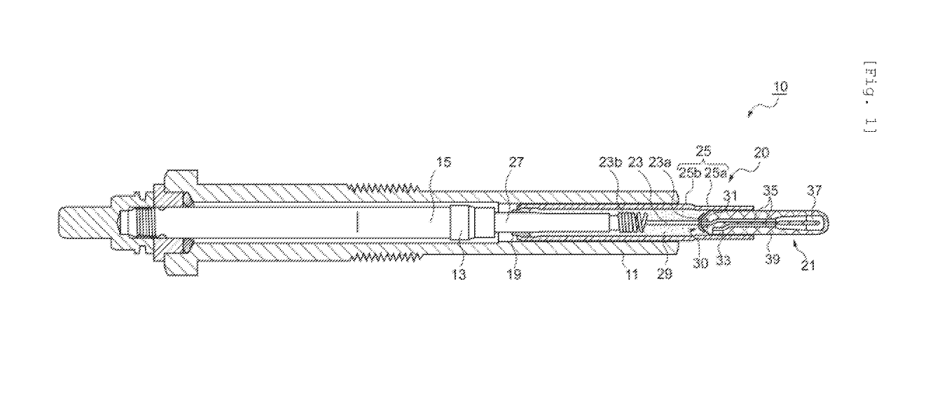

FIG. 1 is a cross-sectional view of a glow plug 10 for diesel engine in accordance with a first embodiment of the invention.

The glow plug 10 shown in FIG. 1 is configured as a ceramic heater-type glow plug including a ceramic heater assembly 20. The ceramic heater assembly 20 includes as main components a ceramic heater 21, an electrode lead-out hardware 23, an electrode lead-out rod 27, a metal outer cylinder (sheath) 25 and the like.

The ceramic heater 21 includes a U-shaped ceramic heating element 37 buried in a ceramic insulating substrate 39 forming the body of the ceramic heater 21. A positive electrode 31 and a negative electrode 33 are connected to the ends of the ceramic heating element 37 by respective metal leads 35. The negative electrode 33 is led out to the outer circumference surface of the ceramic insulating substrate 39 and electrically connected to the inner surface of the metal outer cylinder 25 by joining, such as brazing. The positive electrode 31 is exposed to the outside at the rear end opposite the tip side in which the ceramic heating element 37 is buried.

A taper is formed on the rear end of the ceramic insulating substrate 39. Then, a cup-shaped head portion 23a formed on the tip side of the electrode lead-out hardware 23 fits over the rear end to establish electrical connection between the positive electrode 31 and the electrode lead-out hardware 23. The head portion 23a of the electrode lead-out hardware 23 is joined to the rear end of the ceramic insulating substrate 39 by brazing or the like.

The electrode lead-out hardware 23 includes a coil portion 23b formed at the rear end side into which the tip of the electrode lead-out rod 27 that is a rigid body formed of a conductive metal is inserted to establish electric connection therebetween. The rear end of the electrode lead-out rod 27 is electrically connected by welding to the tip of an external connection terminal 15. A protection member 13 is placed around the connection between the electrode lead-out rod 27 and the external connection terminal 15 to tightly hold the connection.

The ceramic heater 21 is joined to the inner surface of the metal outer cylinder 25 by brazing or the like. The metal outer cylinder 25 includes: a smaller diameter portion 25a on the tip side to which the ceramic heater 21 is fixed; and a larger diameter portion 25b on the rear end side in which the electrode lead-out hardware 23 and the electrode lead-out rod 27 are mainly placed. The electrode lead-out hardware 23 and the electrode lead-out rod 27 that are electrically connected to the positive electrode 31 of the ceramic heater 21 are fixed within the metal outer cylinder 25 by sealing a mixed insulating powder 29 into the metal outer cylinder 25 and swaging the larger diameter portion 25b. The ceramic heater assembly 20 configured in this way is press-fit into and fixed to a cylindrical housing 11 that is mounting hardware for mounting to a cylinder head of an engine not shown.

The mixed insulating powder 29 sealed into the metal outer cylinder 25 has not only the function of ensuring electrical isolation between the metal outer cylinder 25 and the electrode lead-out hardware 23 and between the metal outer cylinder 25 and the electrode lead-out rod 27, but also the function of fixing the electrode lead-out rod 27 and the function of reinforcing the metal outer cylinder 25 from the inner side against a compressive force applied from the housing 11 to the metal outer cylinder 25 when the ceramic heater assembly 20 is press-fit into the housing 11.

The glow plug 10 having the structure as described above can achieve the compactness of the ceramic heater 21 and also allows low-cost manufacturing due to eliminating the need for welding.

### 2. Manufacturing Process of Ceramic Heater Assembly

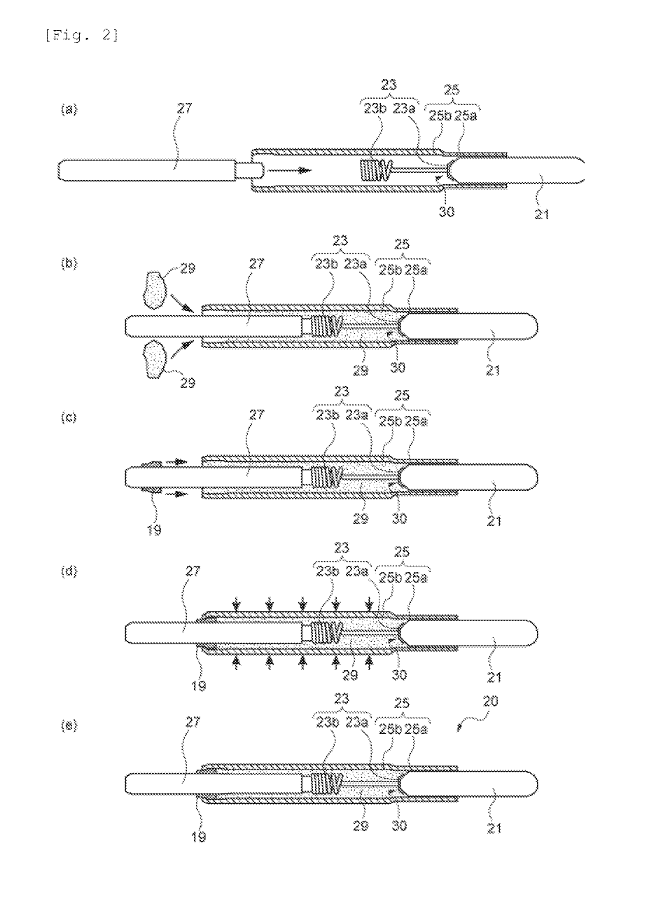

FIGS. 2(a)-2(e) show a manufacturing process of the ceramic heater assembly 20 included in the glow plug 10. Note that, in the description of FIGS. 2(a)-2(e), “tip side” refers to the right side of a figure, and “rear end side” refers to the left side of the figure.

First, in a preparation process not shown, the head portion 23a of the electrode lead-out hardware 23 is fixed by brazing or the like to the rear end side of the ceramic heater 21, then the electrode lead-out hardware 23 and the rear end side of the ceramic heater 21 are inserted into the smaller diameter portion 25a on the tip side of the metal outer cylinder 25 and fixed by brazing or the like.

Then, as shown in FIG. 2(a), the electrode lead-out rod 27 is inserted into the larger diameter portion 25b on the rear end side of the metal outer cylinder 25, and the tip of the electrode lead-out rod 27 is inserted into the coil portion 23b of the electrode lead-out hardware 23.

Then, as shown in FIG. 2(b), the metal outer cylinder 25 is filled with the mixed insulating powder 29 through the gap around the electrode lead-out rod 27. Then, as shown in FIG. 2(c), a seal ring 19 is inserted from the rear end side of the electrode lead-out rod 27 to seal the gap between the metal outer cylinder 25 and the electrode lead-out rod 27. This seals the mixed insulating powder 29 into the metal outer cylinder 25 and also ensures electrical isolation between the metal outer cylinder 25 and the electrode lead-out rod 27.

Then, as shown in FIGS. 2(d)-2(e), the larger diameter portion 25b of the metal outer cylinder 25 is swaged to decrease the diameter of the metal outer cylinder 25. This increases the filling density of the mixed insulating powder 29, tightening the joint between the electrode lead-out rod 27 and the coil portion 23b of the electrode lead-out hardware 23 and the joint between the ceramic heater 21 and the head portion 23a of the electrode lead-out hardware 23.

### 3. Mixed Insulating Powder

Next, the mixed insulating powder 29 sealed into the metal outer cylinder 25 of the glow plug 10 in accordance with the embodiment is described.

The mixed insulating powder 29 has the function of tightly fixing the electrode lead-out rod 27 to the electrode lead-out hardware 23 and the electrode lead-out hardware 23 to the ceramic heater 21, and also has the function of ensuring electrical isolation between the metal outer cylinder 25 and the electrode lead-out rod 27 and between the metal outer cylinder 25 and the electrode lead-out hardware 23. Furthermore, the mixed insulating powder 29 has the function of, when the ceramic heater 21 is operating, dissipating heat generated by large current flowing in the electrode lead-out hardware 23 by conduction in the metal outer cylinder 25 and the housing 11.

The mixed insulating powder 29 used in the embodiment is prepared by mixing a magnesia (MgO) powder as heat-resistant insulating particles 29a and a boron nitride (BN) powder as a lubricity enhancing material 29b. Thus, mixing boron nitride into magnesia, which is conventionally used as an insulating powder, improves lubricity while maintaining heat resistance, electrical insulation performance and heat conductivity.

FIGS. 3(a) and 3(b) are schematic diagrams illustrating how stress propagation varies due to improvement in lubricity of the insulating powder. FIG. 3(a) shows how stress propagates in an insulating power 29′ that includes only the heat-resistant insulating particles 29a and does not include the lubricity enhancing material. FIG. 3(b) shows how stress propagates in the mixed insulating powder 29 that is a mixture of the heat-resistant insulating particles 29a and the lubricity enhancing material 29b.

As shown in FIG. 3(a), with the insulating powder 29′ including only the heat-resistant insulating particles 29a, since slip is not likely to occur among the heat-resistant insulating particles 29a, when stress is applied to the insulating powder 29′, the stress is likely to propagate directly to a member 50 through the heat-resistant insulating particles 29a.

On the other hand, as shown in FIG. 3(b), with the mixed insulating powder 29 mixed with the lubricity enhancing material 29b, when stress is applied to the mixed insulating powder 29, since slip occurs among the heat-resistant insulating particles 29a due to the lubricity enhancing material 29b, load distribution deviation of stress is reduced. This would reduce the stress reaching the member 50.

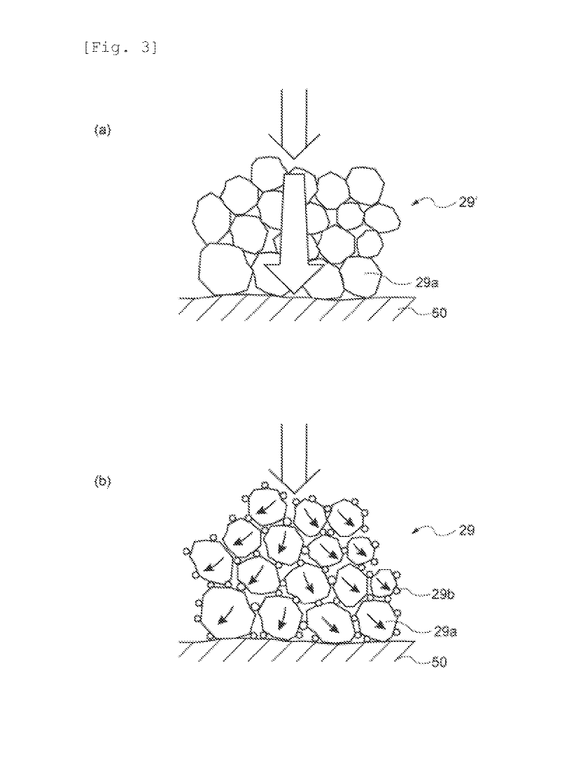

FIG. 4 schematically shows a distribution of stress applied to the connection between the rear end of the ceramic heater 21 and the head portion 23a of the electrode lead-out hardware 23 when the metal outer cylinder 25 is filled with the mixed insulating powder 29 mixed with the lubricity enhancing material 29b and swaged.

When the diameter of the larger diameter portion 25b of the metal outer cylinder 25 is decreased, stress occurs from the periphery to the center of the larger diameter portion 25b. The stress propagates in the metal outer cylinder 25 through the mixed insulating powder 29 and reaches also the connection 30 between the head portion 23a of the electrode lead-out hardware 23 and the rear end of the ceramic heater 21. At this time, since slip occurs among the mixed insulating powder 29, load distribution deviation within the metal outer cylinder 25 is reduced, which can prevent the connection 30 from being damaged due to swaging.

Any appropriate powder that is superior in heat resistance, electrical insulation performance and heat conductivity may be suitably used for the heat-resistant insulating particles 29a included in the mixed insulating powder 29. A material conventionally used as an insulating powder is enough for the heat-resistant insulating particles 29a. In the glow plug 10 in accordance with the embodiment, a magnesia power is used that includes a fine powder of primary particles of equal to or less than 5 μm with a particle diameter of 30-200 μm and an average particle diameter of 75 μm or so.

Furthermore, the lubricity enhancing material 29b needs to be superior particularly in lubricity, and also needs to provide electrical insulation performance and heat conductivity as the mixed insulating powder 29 and heat resistance of up to about 500° C. to endure the working condition of a glow plug used in an engine. Any appropriate powder meeting this requirement may be suitably used, however hexagonal boron nitride (h-BN) is preferable because of its superiority in stability in the air and easy handling. Since hexagonal boron nitride is bound by van der Waals' forces, which is a weak binding force, slip is likely to occur between the layers forming the crystal structure, providing solid lubricity.

Preferably, the lubricity enhancing material 29b has an average particle diameter smaller than that of the heat-resistant insulating particles 29a. Employing the lubricity enhancing material 29b meeting this requirement facilitates the intervening of the lubricity enhancing material 29b among the heat-resistant insulating particles 29a. Furthermore, employing this lubricity enhancing material 29b can increase the filling density of the mixed insulating powder 29 within the metal outer cylinder 25, which can tightly hold the electrode lead-out hardware 23 and the electrode lead-out rod 27 and can also dissipate heat generated from the electrode lead-out hardware 23 by efficient conduction in the metal outer cylinder 25.

Furthermore, preferably, the lubricity enhancing material 29b has a heat conductivity higher than that of the heat-resistant insulating particles 29a. Employing the lubricity enhancing material 29b meeting this requirement can prevent the heat conductivity of the mixed insulating powder 29 from being lower than that of the heat-resistant insulating particles 29a. Thus, when the ceramic heater 21 is operating, heat generated from the electrode lead-out hardware 23 can be efficiently conducted to the metal outer cylinder 25 to prevent oxidation of the electrode lead-out hardware 23.

Furthermore, preferably, the lubricity enhancing material 29b has a relative permittivity lower than that of the heat-resistant insulating particles 29a. Employing the lubricity enhancing material 29b meeting this requirement can prevent the electrical insulation performance of the mixed insulating powder 29 from being lower than that of the heat-resistant insulating particles 29a. This can provide lubricity to the mixed insulating powder 29 without lowering the electrical insulation performance.

Furthermore, preferably, the mixing ratio of the heat-resistant insulating particles 29a and the lubricity enhancing material 29b is determined so that the tapping density of the mixed insulating powder 29 will be at its maximum. Mixing the heat-resistant insulating particles 29a and the lubricity enhancing material 29b to meet this requirement can maximize the filling density of the mixed insulating powder 29, which can tightly hold the electrode lead-out hardware 23 and the electrode lead-out rod 27 and can also dissipate heat generated from the electrode lead-out hardware 23 by efficient conduction in the metal outer cylinder 25.

Note that the “tapping density” can be defined as a density that is determined with reference to JlS-Z-2504 (metal powder), JlS-K-5101 (pigment powder) and JlS-R-6126 (artificial abrasive).

### 4. Effect of the Embodiment

The glow plug 10 in accordance with the embodiment described above is configured to use the mixed insulating powder 29 that is a mixture of the heat-resistant insulating particles 29a and the lubricity enhancing material 29b as an insulating powder to be sealed into the metal outer cylinder 25. Accordingly, in the manufacturing process, even when the metal outer cylinder 25 is swaged to decrease its diameter and stress is applied within the metal outer cylinder 25, slip occurs among the heat-resistant insulating particles 29a to reduce the load distribution deviation within the metal outer cylinder 25, which can reduce the stress propagating to the connection 30 between the electrode lead-out hardware 23 and the rear end of the ceramic heater 21. This effect can also be obtained when stress is applied within the metal outer cylinder 25 due to deforming the metal outer cylinder 25 other than swaging the metal outer cylinder 25. Thus, damage of the ceramic heater 21 and the electrode lead-out hardware 23 can be reduced.

Furthermore, the glow plug 10 in accordance with the embodiment is configured so that the same mixed insulating powder 29 is sealed into the whole metal outer cylinder 25. Accordingly, two stages of insulating powder filling process in which, in one stage, an area around the connection 30 between the electrode lead-out hardware 23 and the rear end of the ceramic heater 21 is filled with an insulating powder and in the other stage, the other area is filled with a different insulating powder is not required. Thus, according to the glow plug 10 in accordance with the embodiment, the glow plug 10 in which the possibility of the ceramic heater 21 or the electrode lead-out hardware 23 being damaged by stress generated due to deformation of the metal outer cylinder 25 is reduced can be efficiently produced.

### Other Embodiment

The glow plug 10 in accordance with the embodiment described above is intended to illustrate one aspect of the invention and is not intended to limit the invention, so any appropriate modification can be made to the embodiment within the scope of the invention. For example, the glow plug 10 in accordance with the embodiment can be modified as follows.

(1) The components included in the glow plug 10 described in the embodiment are only an example and can be appropriately modified.

(2) The glow plug 10 in accordance with the embodiment is configured so that the positive electrode is led out to the outside by the electrode lead-out hardware 23 and the electrode lead-out rod 27, but the way of leading out the positive electrode is not limited to this configuration. For example, the positive electrode 31 of the ceramic heater 21 may be connected to the external connection terminal 15 by one wire.

(3) The glow plug 10 in accordance with the embodiment is configured so that the same mixed insulating powder 29 is sealed into the whole metal outer cylinder 25, but at least only the tip side in which the connection 30 between the positive electrode 31 of the ceramic heater 21 and the head portion 23a of the electrode lead-out hardware 23 is positioned may be filled with the mixed insulating powder 29 mixed with the lubricity enhancing material 29b. Specifically, the process of filling the metal outer cylinder 25 with an insulating powder may be divided to two stages in which, first, an area is filled with the mixed insulating powder 29 mixed with the lubricity enhancing material 29b, then the other area is filled with only the heat-resistant insulating particles 29a, such as magnesia. Even when configured in this way, the propagation of the stress generated by swaging to the connection 30 between the positive electrode 31 of the ceramic heater 21 and the head portion 23a of the electrode lead-out hardware 23 may be reduced.

### Example

An example of the ceramic heater-type glow plug in accordance with the invention is described below.

In this example, a mixed insulating powder is prepared using magnesia (MgO) and hexagonal boron nitride (h-BN) shown in Table 1.

TABLE 1

| | h-BN | MgO |
|---|---|---|
| THEORETICAL DENSITY | 2.27 | 3.58 |
| (g/ccm) | | |
| AVERAGE PARTICLE | 2.0 | 75 |
| DIAMETER D50 (μm) | | |
| TAPPING DENSITY | 0.4 | 1.7 |
| (g/ccm) | | |
| vs. THEORETICAL | 17.6 | 47.5 |
| DENSITY (%) | | |
| HEATRESISTANT | 900° C. | 2500° C. |
| TEMPERATURE (IN THE | | |
| AIR) | | |
| HEAT CONDUCTIVITY | 40-60 | 13 |
| (w/mK) | | |
| RELATIVE | 4 | 10 |
| PERMITTIVITY | | |
| SOLID LUBRICITY | HIGH | LOW |

(1) Tapping Density

With a total weight of the mixed insulating powder of 100 wt %, mixed insulating powders with a mixed amount of hexagonal boron nitride of 0 wt %, 5 wt %, 10 wt %, 13 wt % and 15 wt % were prepared, then the tapping density (g/ccm) of the mixed insulating powders was measured.

For the tapping density, 10 ccm of mixed insulating powder was put into a graduated cylinder, then 180 taps were given by hand to the graduated cylinder, and then the volume of the mixed insulating powder was measured.

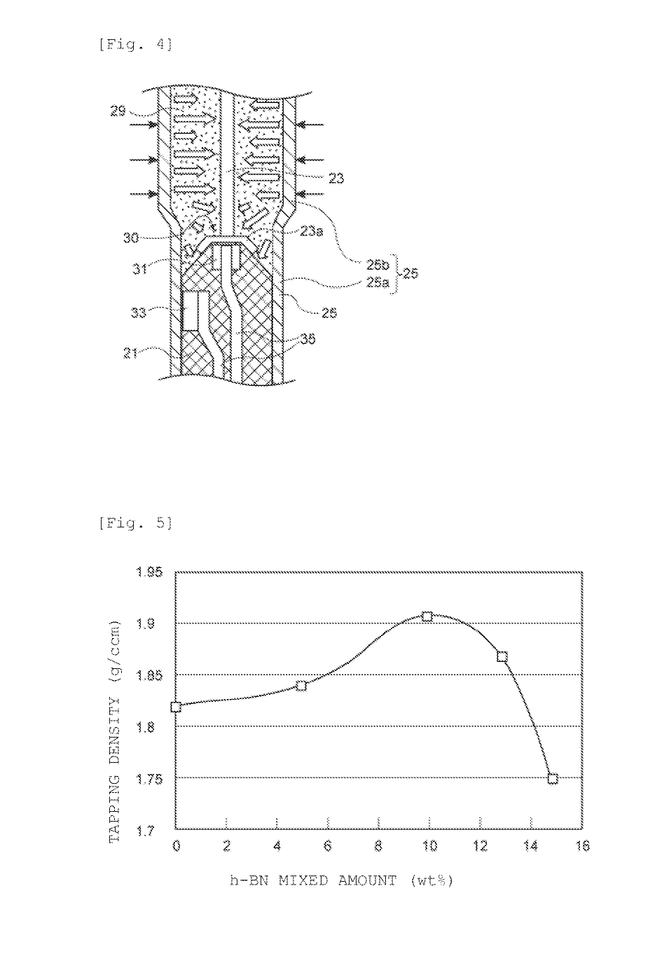

FIG. 5 shows a result of measuring the tapping density (g/ccm) versus the mixed amount (wt %) of hexagonal boron nitride.

As shown in FIG. 5, with magnesia and hexagonal boron nitride shown in Table 1, the tapping density was at maximum when the mixed amount of hexagonal boron nitride was about 10 wt %. As seen from this result, with the mixed amount of hexagonal boron nitride of about 10 wt %, swaging enables the electrode lead-out hardware, the electrode lead-out rod and the connection between them to be more tightly held.

(2) Heater Resistance

Next, among the mixed insulating powders prepared as described above, the mixed insulating powders with a mixed amount of hexagonal boron nitride of 0 wt %, 10 wt % and 15 wt % were used to fabricate ceramic heater assemblies according to the steps shown in FIGS. 2(a)-2(e). Thus, the ceramic heater assemblies were fabricated with the same mixed insulating powder 29 sealed into the whole metal outer cylinder 25. For each mixed insulating powder with a different mixed amount of hexagonal boron nitride, three ceramic heater assemblies were fabricated.

The basic configuration of the ceramic heater assembly was as shown in FIG. 2. In this example, in order to facilitate determination of the extent of the damage of the electrode lead-out hardware and the ceramic heater assembly due to swaging, a ceramic heater assembly 20A was configured as shown in FIG. 6 in which a smaller diameter portion 39A was formed on the rear end of a ceramic heater 21A, then a cylindrically-shaped head portion 23Aa of an electrode lead-out hardware 23A fits over the smaller diameter portion 39A.

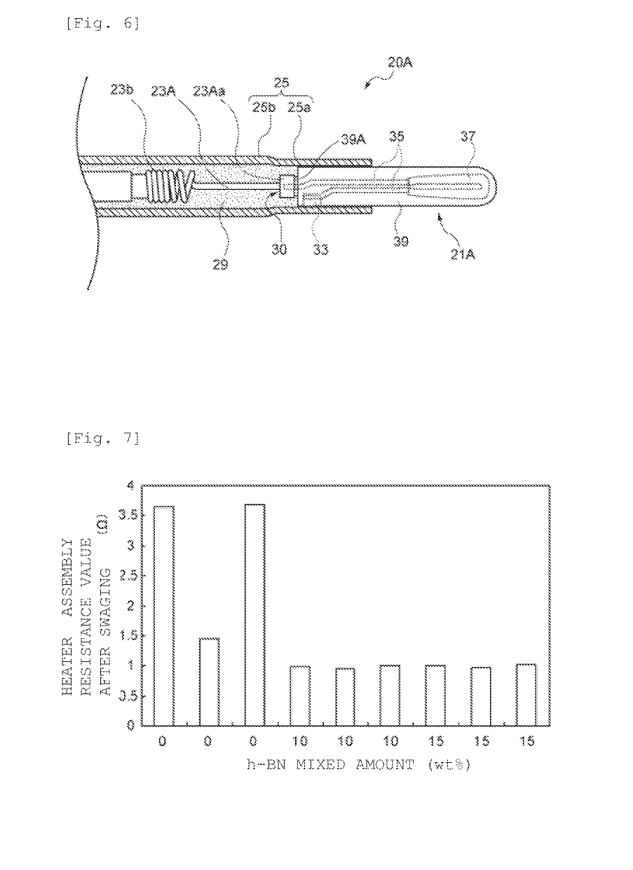

The fabricated ceramic heater assemblies were energized and their resistance values were measured. The resistance values were measured using a milli-ohm tester employing a four-terminal method. FIG. 7 shows a result of the measurement.

As shown in FIG. 7, when the mixed insulating powder including only magnesia with a mixed amount of hexagonal boron nitride of 0 wt % is used, high resistance value was detected. On the other hand, when the mixed insulating powder mixed with hexagonal boron nitride was used, the resistance value was stable at a low level so it was determined that the resistance value could be maintained.

(3) Surface Temperature

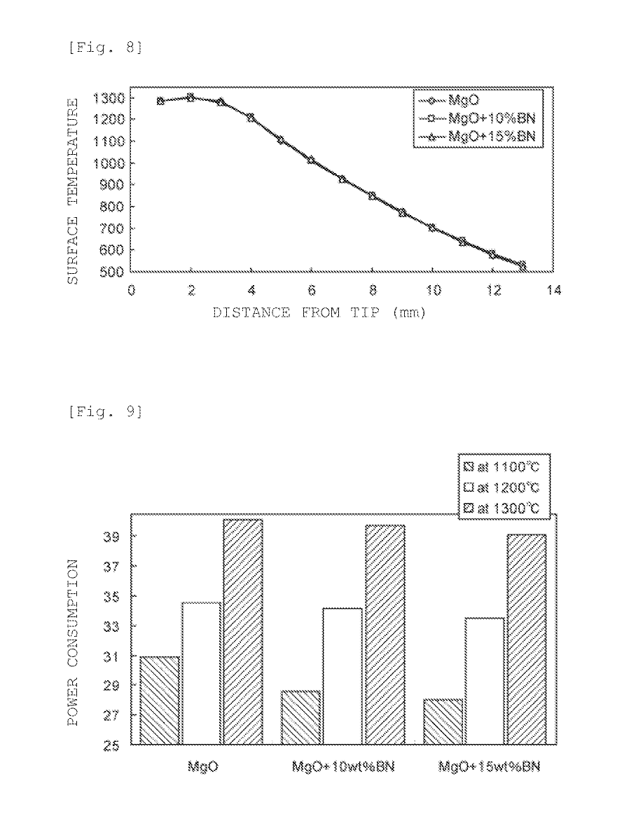

Next, among the fabricated ceramic heater assemblies, one ceramic heater assembly is picked for each mixed amount of hexagonal boron nitride, then each of the picked ceramic heater assemblies was energized and the surface temperature of its ceramic heater was measured. The surface temperature was measured versus the distance from the tip of the ceramic heater by 1 mm step using a radiation thermometer. FIG. 8 shows a result of the measurement.

As shown in FIG. 8, even when mixed with hexagonal boron nitride, the surface temperature of the ceramic heater was almost unaffected.

(4) Power Consumption

Next, among the fabricated ceramic heater assemblies, one ceramic heater assembly is picked for each mixed amount of hexagonal boron nitride, then each of the picked ceramic heater assemblies was energized and the power consumption of its ceramic heater was measured when the temperature at the position 2 mm away from the tip was 1,100° C., 1,200° C. and 1,300° C. FIG. 9 shows a result of the measurement.

As shown in FIG. 9, even when mixed with hexagonal boron nitride, the power consumption of the ceramic heater does not increase, and, the larger the mixed amount of hexagonal boron nitride, the smaller the power consumption tends to be even at the same temperature.

(5) Heat Resistance

As shown in Table 1, the heat-resistant temperature in the air of the hexagonal boron nitride that was used is lower than that of magnesia, however, since it is known that the temperature within the metal outer cylinder 25 never exceeds 500° C. even when the glow plug is operating, the heat resistance is ensured.

(6) Heat Conductivity

Furthermore, the heat conductivity of hexagonal boron nitride is higher than that of magnesia, and the glow plug manufactured using the mixed insulating powder 29 mixed with hexagonal boron nitride will have a heat conductivity higher than that of the glow plug filled with magnesia only.

(7) Electrical Insulation Performance

Furthermore, the relative permittivity of hexagonal boron nitride is smaller than that of magnesia, and the glow plug manufactured using the mixed insulating powder 29 mixed with hexagonal boron nitride will be superior in electrical insulation performance to the glow plug filled with magnesia only.

As described above, when the ceramic heater assembly 20A is fabricated by sealing the mixed insulating powder 29 mixed with hexagonal boron nitride into the metal outer cylinder 25 the ceramic heater assembly 20A can be fabricated, which can tightly hold the electrode lead-out hardware 23, the electrode lead-out rod 27 and the connection therebetween, while maintaining good heat resistance, heat conductivity and electrical insulation performance of the mixed insulating powder 29 and not affecting the heater resistance, surface temperature and power consumption.

Furthermore, the ceramic heater assembly 20A fabricated by sealing the mixed insulating powder 29 mixed with hexagonal boron nitride into the metal outer cylinder 25, since lubricity is given to the mixed insulating powder 29, even when swaged, could suppress damage of the rear end 39A of the ceramic heater 21A and the electrode lead-out hardware 23A.

1. A ceramic heater-type glow plug comprising: a ceramic heater; a metal outer cylinder holding the ceramic heater at one end side and having an other end side inserted into an inner hole of a housing and fixed to the housing; and an electrode lead-out member connected to one electrode of the ceramic heater within the metal outer cylinder,
wherein heat-resistant insulating particles are sealed into the metal outer cylinder as a sealing material, and
wherein at least an area around the connection between the one electrode and the electrode lead-out member is filled with a mixed insulating powder mixed with a lubricity enhancing material for improving lubricity among the heat-resistant insulating particles.

2. The ceramic heater-type glow plug according to claim 1, wherein the lubricity enhancing material has an average particle diameter smaller than that of the heat-resistant insulating particles.

3. The ceramic heater-type glow plug according to claim 1, wherein the lubricity enhancing material has a heat conductivity higher than that of the heat-resistant insulating particles.

4. The ceramic heater-type glow plug according to claim 1, wherein a mixing ratio of the heat-resistant insulating particles and the lubricity enhancing material is determined so that a tapping density of the mixed insulating powder will be higher than that of the heat-resistant insulating particles.

5. The ceramic heater-type glow plug according to claim 1, wherein the heat-resistant insulating particles are magnesia (MgO), and the lubricity enhancing material is hexagonal boron nitride (h-BN).

6. The ceramic heater-type glow plug according to claim 1, wherein the mixed insulating powder is sealed into the whole metal outer cylinder.

7. The ceramic heater-type glow plug according to claim 2, wherein the lubricity enhancing material has a heat conductivity higher than that of the heat-resistant insulating particles.

8. The ceramic heater-type glow plug according to claim 7, wherein a mixing ratio of the heat-resistant insulating particles and the lubricity enhancing material is determined so that a tapping density of the mixed insulating powder will be higher than that of the heat-resistant insulating particles.

9. The ceramic heater-type glow plug according to claim 8, wherein the heat-resistant insulating particles are magnesia (MgO), and the lubricity enhancing material is hexagonal boron nitride (h-BN).

10. The ceramic heater-type glow plug according to claim 9, wherein the mixed insulating powder is sealed into the whole metal outer cylinder.
